(19) United States
(12) Patent Application Publication
(10) Pub. No.: US 2012/0173524 A1
(43) Pub. Date: Jul. 5, 2012

(54) CAPTURING COLLECTION INFORMATION FOR INSTITUTIONS

(76) Inventors: Ian Connor, Cambridge, MA (US); Ramy Arnaout, Chestnut Hill, MA (US); Matthew Moskwa, Cambridge, MA (US); Anit Das, Cambridge, MA (US)

(21) Appl. No.: 13/340,786

(22) Filed: Dec. 30, 2011

Related U.S. Application Data
(60) Provisional application No. 61/428,883, filed on Dec. 31, 2010.
(60) Provisional application No. 61/437,600, filed on Jan. 29, 2011.

(51) Int. Cl. G06F 17/30

(52) U.S. Cl. 707/736; 707/E17.058

(57) ABSTRACT

Information on collections may be gathered from publishing platforms and institutional library services. The information may be imported and analyzed to aid in utilization of the collections. Additional information may be scraped from web pages to augment the data imported. Alternatively, data may be scraped from web pages even if import of data has not been performed.

### RELATED APPLICATIONS

This application claims the benefit of U.S. provisional patent application “Capturing Collection Information for Institutions” Ser. No. 61/428,883, filed Dec. 31, 2010 and U.S. provisional patent application “Capturing Library Collection Information” Ser. No. 61/437,600, filed Jan. 29, 2011. Each of the foregoing applications is hereby incorporated by reference in its entirety.

### FIELD OF INVENTION

This application relates generally to library collections and more particularly to the capturing collection information for institutions.

### BACKGROUND

Libraries and institutions contain massive amounts of information with libraries often being considered the protectors of knowledge in society. Libraries provide a function as storage repositories and distribution centers for all sorts of information. Research and analysis is performed using libraries, based on this massive amount of information. Historically libraries have been brick-and-mortar locations with extensive shelving to contain books, journals, and magazines. More recently libraries have become virtual locations and even brick-and-mortar physical libraries can have significant virtual holdings that are available across various networks. These holdings are electronic media in various formats including books, magazines, journals, and conference proceedings along with audio and video recordings. These collections can cover everyday life, include engineering analysis, and relate fundamental scientific discoveries. Previously, card catalogs would contain listings of the contents of a library while now the contents of a library are categorized and listed electronically.

Librarians have been the curators of library collections over time. Within libraries, specialist librarians have developed who track collections, order new materials, and help researchers find information for which they are searching. Further sub-specialists have developed within libraries, being experts on collections in specific fields, such as business, medicine, engineering, or smaller areas within one of these fields. The clerical task of tracking the associated massive amounts of material is truly daunting. The quantity of information required can easily overwhelm even the best of librarians. Collection information can include the title, publisher, location of publisher, authors, dates of publications, as well as various other information types. Each different collection can have relevant information formatted and organized differently. The tedious effort required to understand this information, use it properly, and grow a collection appropriately is beyond the capability of librarians as a whole.

### SUMMARY

Library and institution collection information can be spread across numerous web pages in varying formats. Collecting and analyzing the relevant information can be invaluable in the proper access and utilization of the collection by employees, students, and others who have access to the collections.

A computer implemented method is disclosed for obtaining information comprising: accessing a publishing platform; importing data related to a collection from the publishing platform; analyzing the data related to the collection which was imported, resulting in an analysis; and storing the analysis in a computer system. The collection may include one or more of electronic books, electronic journals, and papers. The accessing may be accomplished by navigating to a publicly available page. The accessing may be accomplished by logging into the publishing platform using one of a group including a known login, a proxy login, and a VPN. The importing may include downloading one or more files containing the data related to the collection. The importing may further comprise: navigating to a page containing the data related to the collection; and grabbing subscription information on the collection. The method may further comprise scraping the page, which was navigated to, for additional information beyond that which was grabbed. The method may further comprise improving the importing by: identifying an alias for a title of the collection from the publishing platform; and analyzing the data related to the collection using the alias for the title. The method may further comprise storing the data related to the collection for future usage. The data related to collections may include one or more from a group consisting of an electronic journal URL, database information, an ISSN number, an ISBN number, dates for the collection, a source for the collection, and availability of the collection. The method may further comprise determining whether a quality criterion is met by the data related to the collection. The method may further comprise identifying an error in the data related to the collection. The error may be one of a group consisting of manual error and system error. The method may further comprise notifying the publishing platform of the error which was identified. The method may further comprise monitoring the collection from the publishing platform to identify changes in the collection.

In embodiments, a computer implemented method for obtaining information may comprise: accessing an institutional library service; scraping the institutional library service for data related to a collection; analyzing the data related to the collection which was scraped, resulting in an analysis; and storing the analysis in a computer system. The scraping may further comprise: identifying a location of a starting page for the institutional library service; plugging in an arrangement for the data related to the collection on the starting page; pulling the data related to the collection from the arrangement; and exporting the data related to the collection into a database. The method may further comprise formatting the data related to the collection into a spreadsheet. The method may further comprise improving the scraping by: marking a row within the database for analysis; identifying extraneous characters in the data related to the collection within the row; and modifying the pulling to avoid the extraneous characters.

In some embodiments, a computer program product embodied in a non-transitory computer readable medium for obtaining information may comprise: code for accessing a publishing platform; code for importing data related to a collection from the publishing platform; code for analyzing the data related to the collection which was imported, resulting in an analysis; and code for storing the analysis in a computer system. In embodiments, a computer system for obtaining information may comprise: a memory for storing instructions; one or more processors attached to the memory wherein the one or more processors are configured to: access a publishing platform; import data related to a collection from the publishing platform; analyze the data related to the collection which was imported, resulting in an analysis; and store the analysis in a computer system. In embodiments, a computer program product embodied in a non-transitory computer readable medium for obtaining information may comprise: code for accessing an institutional library service; code for scraping the institutional library service for data related to a collection; code for analyzing the data related to the collection which was scraped, resulting in an analysis; and code for storing the analysis in a computer system. In some embodiments, a computer system for obtaining information may comprise: a memory for storing instructions; one or more processors attached to the memory wherein the one or more processors are configured to: access an institutional library service; scrape the institutional library service for data related to a collection; analyze the data related to the collection which was scraped, resulting in an analysis; and store the analysis in a computer system.

Various features, aspects, and advantages of embodiments will be apparent from the following description.

### BRIEF DESCRIPTION OF THE DRAWINGS

The following detailed description of certain embodiments may be understood by reference to the following figures wherein:

FIG. 1 is a flow diagram for importing collection information.

FIG. 2 is a flow diagram with details on importing.

FIG. 3 is a flow diagram for scraping of collection information.

FIG. 4 is a flow diagram for details on scraping.

FIG. 5 is a flow diagram for scraping improvements.

FIG. 6 is an example web page for scraping.

FIG. 7 is an example web page showing IP ranges.

FIG. 8 is an example web page showing IP ranges by platform.

FIG. 9 includes example spreadsheet information on collections.

FIG. 10 includes an example view of holdings.

FIG. 11 includes an example overview of holdings.

FIG. 12 includes an example library report.

FIG. 13 is a system diagram showing client server interaction.

### DETAILED DESCRIPTION

The present disclosure provides a description of various methods, systems, and apparatus associated with the gathering of collection information from libraries and institutions. Libraries contain vast amounts of valuable information. Analyzing the information contained in libraries and available from publishers, to which the libraries have access, is a very useful exercise. Automatically gathering collection information using one or more computer systems can significantly increase the usefulness of any collection or group of collections. Collections are frequently updated and, without gathering the latest information on a collection, the knowledge included in these updates can be missed. Patrons of libraries, such as professors and researchers, depend on the information contained within the collections in order to effectively perform their teaching, development, and research tasks. By automatically gathering the collection information, such data is kept up to date and becomes easily accessible to the library patrons. Without this type of gathering, patrons would miss papers to which they have authorized access. Automatic gathering of collection information therefore eases the efforts of librarians and improves information access to patrons.

The information gathering can include collecting holdings data from journal publisher platforms on a library's behalf. Login credentials from publisher platforms can be used to access the platforms and obtain collection information available to the library. As new holdings become available, the collections information is kept up to date to reflect these new holdings. A landing web page can be provided for a library with tabs that identify holdings information. A collection may be a group of magazines, journals, published serials, books, conference proceedings, or other gathering of materials. A library may be a contiguous, distributed, or virtual grouping of books, magazines, journals, and other library related collections. A library may include a collection of smaller libraries. An institution may be a library, governmental entity, or business which collects books, journals, and other published materials. An institutional library service may be any library-like means for disseminating publications including journals, magazines, books, and the like to patrons. An institutional library service may exist for a university, a corporation, a non-profit entity, a hospital, or the like. A library service may be a consortium of libraries such as, for example, all of the libraries in one state's public universities. A publishing platform can include a publisher's electronically available materials. A publishing platform may include a website or collection of websites. A publishing platform may include an online, digital, or virtual library and downloading of papers from such a platform may be possible using “pdf” or other standard file formats. A publishing platform may include frequently used commercial sites such as Amazon™, Safari™ online, Google™ books, or the like.

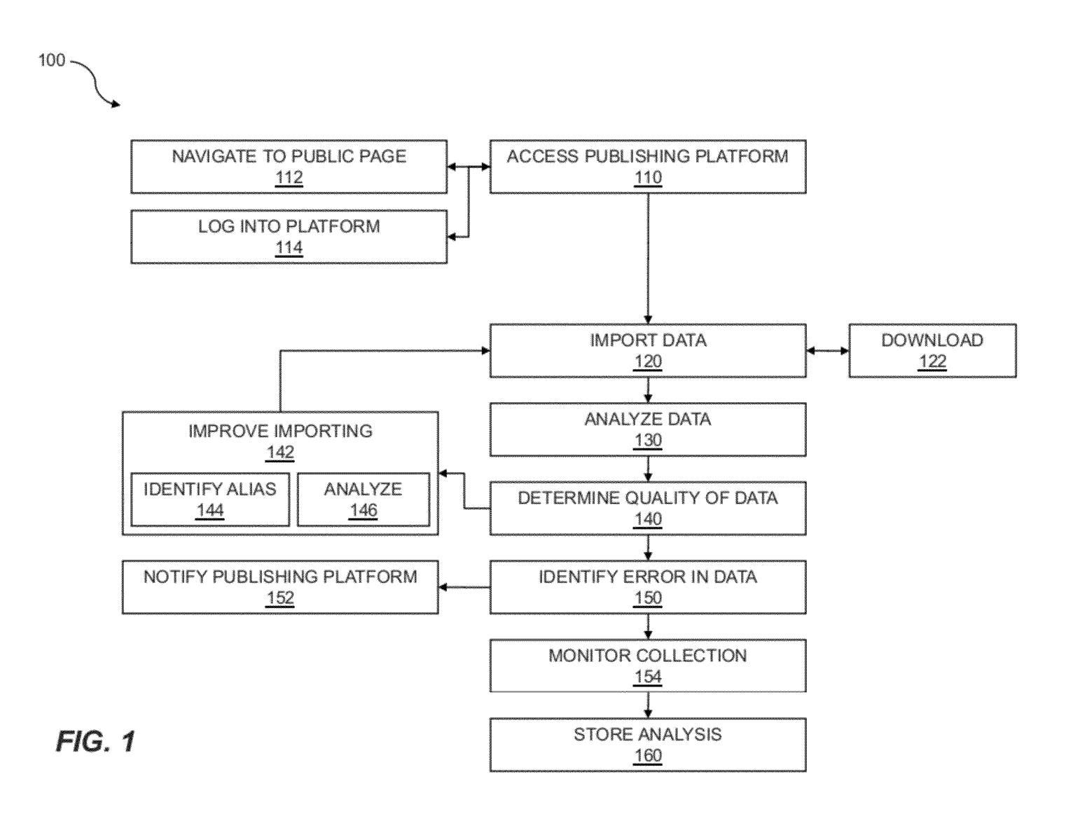

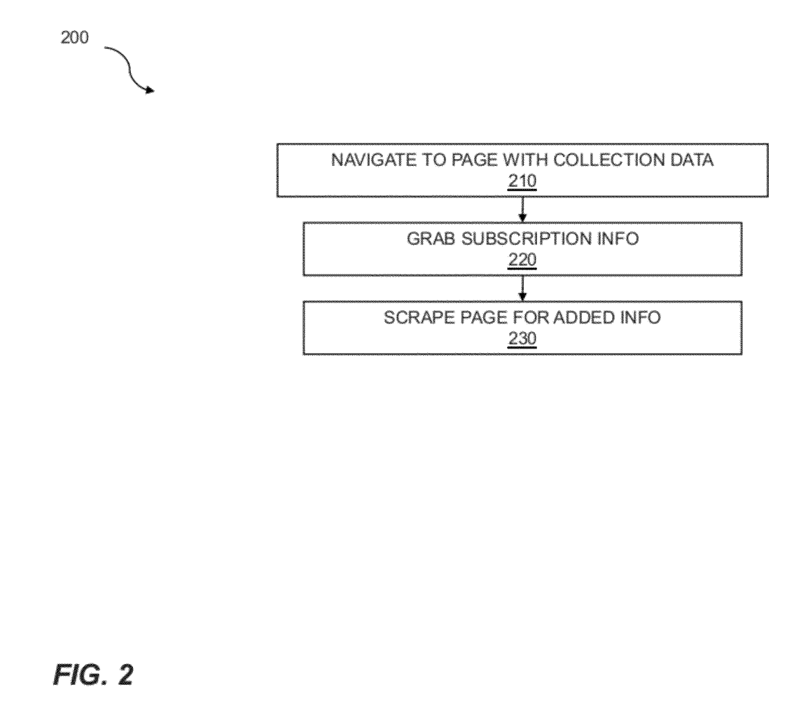

FIG. 1 is a flow diagram for the importing of collection information. A flow 100 is disclosed which is a computer implemented method for obtaining information. The flow 100 may begin with accessing a publishing platform 110. A collection may include one or more of electronic books, electronic journals, and papers. Access can be gained to a publishing platform through a publicly available web page through direct access or by navigating to the publicly available page 112. The accessing may also be accomplished by logging into the publishing platform 114 using one of a group including a known login, a proxy login, a virtual private network (VPN), or by similar means. The logging into the publishing platform may use login credentials provided by a library or institution as if the library or institution was directly accessing the publishing platform. The publishing platform could be a publisher, a commercial retailer, and so on. The importing may include downloading 122 one or more files containing the data related to the collection. The files may include some or all of the information needed on the collection. The flow 100 continues with importing data 120 related to a collection from the publishing platform. The data can include a collection title, a publisher name, a publisher's location, dates for the collection, any gaps in the collection dates such as during an embargo timeframe, and so on. The data related to collections may include one or more from the group consisting of an electronic journal uniform resource locator (URL), database information, an international standard serial number (ISSN), an international standard book number (ISBN), dates for the collection, a source for the collection, and availability of the collection. The importing can be accomplished by selecting an “import” button, through a download capability, through a file transfer protocol (FTP) capability, and the like. More detail on importing is included in the description of FIG. 2.

The flow 100 continues with analyzing the data 130 related to the collection which was imported, resulting in an analysis. The data may be analyzed to ensure that the proper collection was accessed, to ensure that the proper data was collected, to determine if more data is available, as well as other possible analyses. The flow 100 may continue with determining whether a quality criterion is met by the data 140 related to the collection. Quality criteria may include checking for extraneous characters or evaluating for thoroughness of data collected, along with other quality checks. In some embodiments, the flow 100 may include improving the importing 142 based on the quality checks. When errors are found in the data imported, the importing algorithm may be updated to avoid such importing errors. A software algorithm may modify the importing. In embodiments, quality problems may be reviewed with human intervention and the importing algorithm may be correspondingly corrected. In some embodiments, the improving the importing includes identifying an alias 144 for a title of the collection from the publishing platform and analyzing 146 the data related to the collection using the title based on the alias. The flow 100 may continue with identifying an error in the data 150 related to the collection. Errors may include extraneous characters, incorrect sequence dates for a collection, information fields being swapped, and other possible errors. The error may be one of a group consisting of a manual error and a system error. An example manual error is a transcription mistake made by a person. Two or more characters may be transposed from their correct positions. An example system error is an incorrect optical character recognition (OCR) operation. Systematic errors may become worse over time as they are propagated through collection records. A publishing platform may not have updated its records to reflect new locations for where papers are stored. Links on web pages may be wrong and direct a patron to an incorrect or nonexistent website. A website may only provide an abstract rather than correctly direct a user to the full paper itself. These and other errors or enhancements may be identified. In some embodiments, once an error is identified the importing process may be modified to improve the importing 142. Code may be generated to work around the error which was identified so that the data can be properly imported. The flow 100 may continue with notifying the publishing platform or library 152 of the error which was identified. Notification may be performed by email, web site notification, Twitter™, Facebook™, LinkedIn™, Google+™, or other social networking or notification means. The flow 100 may continue with monitoring the collection 154 from the publishing platform to identify changes in the collection. Changes to the collection may be communicated to the librarian or other user to help them better assist library patrons. Collection changes which are identified may be automatically communicated to the user. The flow 100 continues with storing the analysis 160 in a computer system. Further, the storing may include storing the data related to the collection for future usage. Various steps in the flow 100 may be changed in order, repeated, omitted, or the like without departing from the disclosed inventive concepts.

FIG. 2 is a flow diagram with details on importing. The flow 200 may begin with navigating to a page containing data related to a collection 210. In some embodiments, the navigating can be inputting a specific URL, in many ways like using a bookmark in a web browser. In other embodiments the navigating can involve being directed to a page relative to a publicly accessible page or a login page. The navigating can also be providing a staring page or a class of pages to be examined. The flow 200 may continue with grabbing subscription information 220 on the collection. The grabbing can involve downloading the collection information. The downloading can be accomplished by downloading a spreadsheet, database, text version, or similar soft copy of the collection information. The grabbing can also include copying-and-pasting, image capture, downloading a page, reading in a page, or the like. The flow 200 may continue with scraping the page, which was navigated to, for additional information 230 beyond that which was grabbed. Scraping will be covered in more detail shortly. The additional information can be collection data or comments about the collection data which are missed during a typical import. The scraping can also capture data which was missed due to a difference in formatting between that which was expected and that which was included on the web page being accessed. Various steps in the flow 200 may be changed in order, repeated, omitted, or the like without departing from the disclosed inventive concepts.

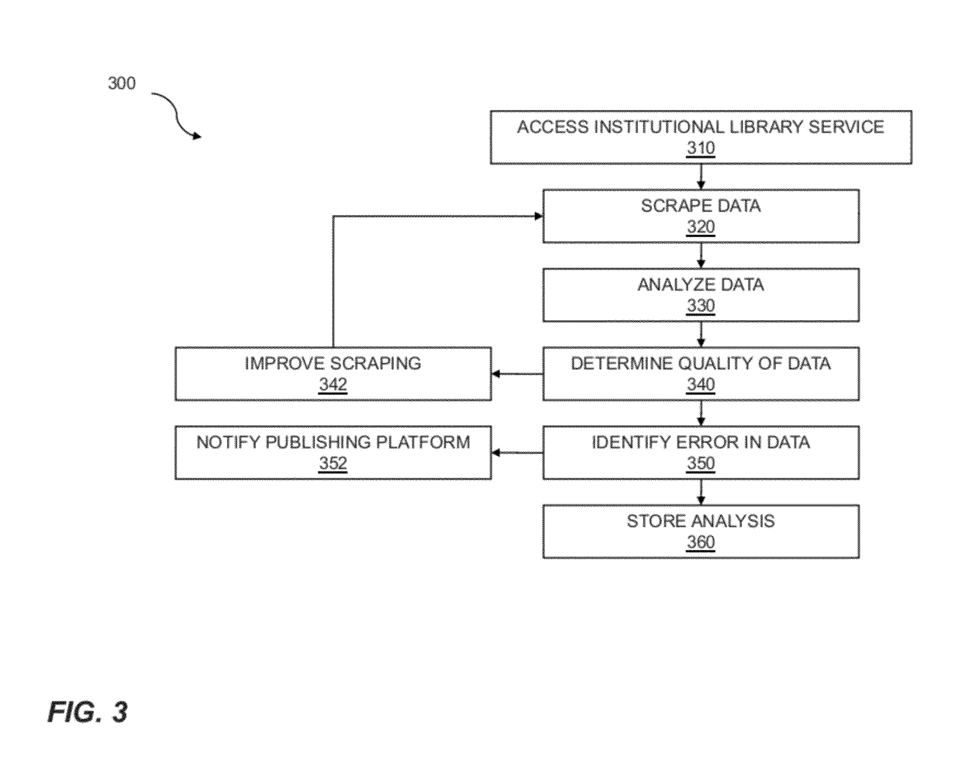

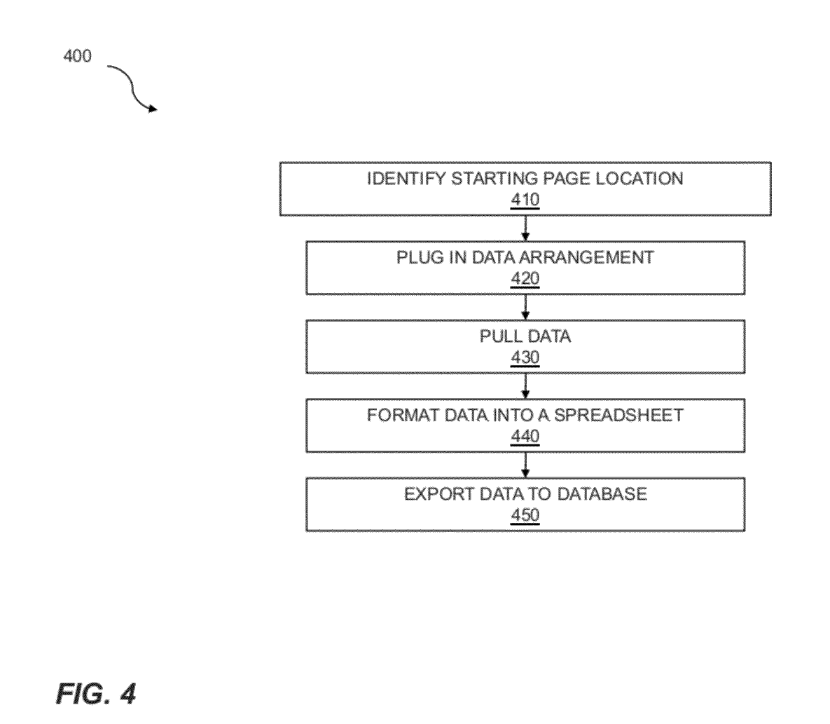

FIG. 3 is a flow diagram for scraping of collection information. A flow 300 for a computer implemented method for obtaining information is described. The flow 300 may begin with accessing an institutional library service 310. The institutional library service may be a library of a college, university, graduate school, community, governmental agency, or a company. Access can be gained to an institutional library service by directly accessing a publicly available web page or by navigating to the publicly available page. The accessing may also be accomplished by logging in using one of a group comprising a known login, a proxy login, a virtual private network (VPN), or by similar means. The logging into the institutional library service may use login credentials provided by a library or institution. In some embodiments, the accessing is accomplished by accessing a publishing platform. The flow 300 continues with scraping for data 320 related to a collection. The data can include a collection title, a publisher name, a publisher's location, dates for the collection, any gaps in the collection dates such as during an embargo timeframe, and so on. The data related to collections may include one or more from the group comprising an electronic journal URL, database information, an ISSN number, an ISBN number, dates for the collection, a source for the collection, and availability of the collection. The scraping, also known as web harvesting or web data extraction, can be accomplished by downloading a web page for post processing, through copy-and-pasting, through image capture, or through other capture means. Scraping may include parsing the web page into data fields and extracting the data in those data fields. More detail on scraping is included in the description of FIG. 4.

The flow 300 continues with analyzing the data 330 related to the collection which was scraped, resulting in an analysis. The data may be analyzed to ensure that the proper collection was accessed, to ensure that the proper data was collected, to determine if more data is available, as well as other possible analyses. The flow 300 may continue with determining whether a quality criterion is met by the data 340 related to the collection. Quality criteria may include checking for extraneous characters, evaluating of thoroughness of data collected, along with other quality checks. In some embodiments, an improvement to scraping 342 may be determined based on the quality checks. When errors are found in the scraped data, the scraping algorithm may be updated to avoid such scraping errors. A software algorithm may modify the scraping. In embodiments, quality problems may be reviewed with human intervention and the scraping algorithm may be correspondingly corrected. In some embodiments, the improving the scraping includes identifying an alias for a title of the collection and analyzing the data related to the collection using the title based on the alias. The flow 300 may continue with identifying an error in the data 350 related to the collection. Errors may include extraneous characters, incorrect sequence dates for a collection, information fields being swapped, and other possible errors. The error may be one of a group comprising a manual error and a system error. An example manual error is a transcription mistake made by a person. Two or more characters may be transposed from their correct positions. An example system error is an incorrect optical character recognition (OCR) operation. Systematic errors may become worse over time as they are propagated through collection records. A publishing platform may not have updated its records to reflect new locations for where papers are stored. Links on web pages may be wrong and direct a patron to an incorrect or nonexistent website. A website may only provide an abstract rather than correctly direct a user to the full paper itself. These and other errors or enhancements may be identified. In some embodiments, once an error is identified the scraping process may be modified to improve the scraping 342. Code may be generated to work around the error which was identified so that the data can be properly scraped. The flow 300 may continue with notifying the library or publishing platform 352 of the error which was identified. Notification may be performed by email, web site notification, Twitter™, Facebook™, LinkedIn™, Google+™, or other social networking or notification means. The flow 300 continues with storing the analysis 360 in a computer system. Further, the storing may include storing the data related to the collection for future usage. Various steps in the flow 300 may be changed in order, repeated, omitted, or the like without departing from the disclosed inventive concepts.

FIG. 4 is a flow diagram for details on scraping. A flow 400 for scraping may begin with identifying a location of a starting page 410 for the institutional library service or publishing platform. The location may be a publicly available web page. In some embodiments, the starting page is a web page which the institutional library service created to describe information on its collections. Alternatively, the starting page can be a web page which is accessed through a known login, a proxy login, or a VPN. In some embodiments, the starting page is referred to as an “A to Z” page. On such an “A to Z” page all of the collections for the institutional library service may be accessed in alphabetical order, based on the collection title name. There may be separate web pages which may be accessed for each letter of the alphabet or there may be a page for a range in the alphabet. The flow 400 continues with plugging in an arrangement for the data 420 related to the collection on the starting page. A data arrangement may be a model which identifies the order of the data to be collected and the location on the page. In some embodiments, the data arrangement may be a complete list of the data needing to be obtained on the collection. In embodiments, each of the web pages in a class of web pages may be stepped through to find the needed information. The data arrangement may include a template for expected locations for the information to be located. The data arrangement may include field locations for the information to be collected. The data arrangement may include a mapping for hypertext markup language (HTML) corresponding to the information needed about the collection. In some embodiments, cascading style sheet (CSS) language may be analyzed to determine the locations on the page where specific collection information resides. Key words may be examined on web pages to be able to isolate the collection information. Regular expressions may be examined to identify collection information. Styles and tags may be examined on web pages to identify the collection information. Web page links may be identified.

The data arrangement may vary with different data collections and with different institutional library services. The flow 400 continues with pulling the data 430 related to the collection from the arrangement and can be considered to be ingesting information on the collections. The pulling can be accomplished through copy-and-pasting, through downloading a web page for post processing, through image capture, or through other collection means. Various information associated with collections may be extracted from web pages. Links which were identified may be extracted. These extracted links may be stepped through so that further information on the collections can be obtained. A link resolver may identify the type of information or file which is available by following a given link and thereby download or scrape the web page associated with the link. Executed code may react to the information collected from the web pages to improve the accuracy of the data pulled on the collections. The flow 400 may continue with formatting the data related to the collection into a spreadsheet 440. This data may comprise the collection information. The data which was pulled can be rearranged so that various collections all have their data arranged in the same sequence. The formatting may use comma-delimited fields, tab separated fields, or other spreadsheet related formatting. The flow 400 continues with exporting the data related to the collection into a database 450. The data from the collections may be stored on a file on a local or remote computer system. Various steps in the flow 400 may be changed in order, repeated, omitted, or the like without departing from the disclosed inventive concepts.

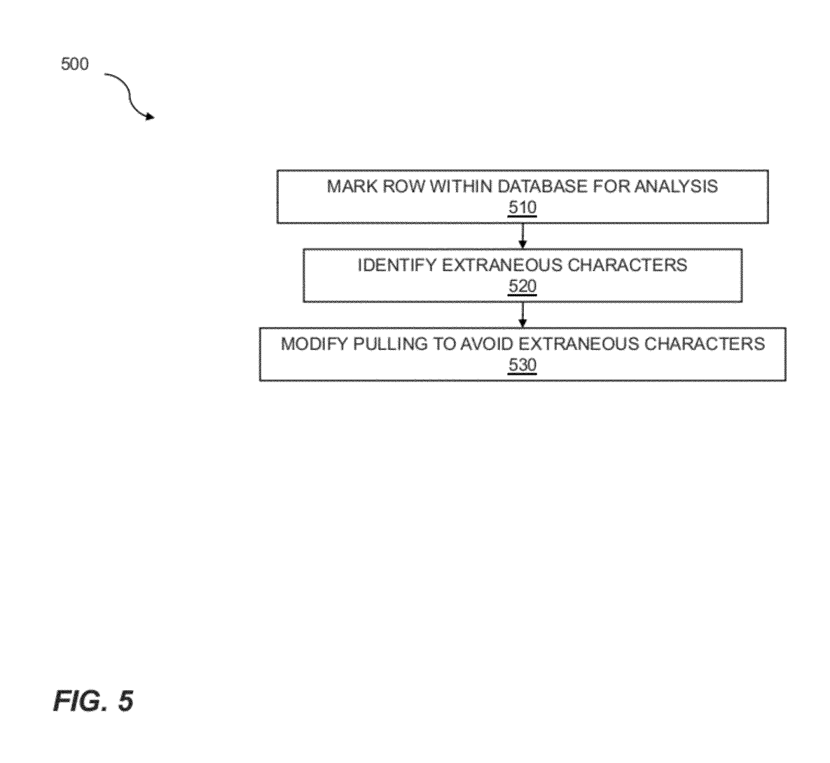

FIG. 5 is a flow diagram for scraping improvements. A flow 500 describes one possible scraping improvement. There are numerous possible scraping improvements all of which could be understood by someone of skill in the art based on this disclosure. The flow 500 begins with marking a row within the database for analysis 510. Each row may be considered an entry for a collection. Each row may be described by a rule. Analysis may be performed to identify extraneous characters 520 in the data related to the collection within the row. Extraneous characters may be recognized by identifying a sequence of letters, numbers, or symbols which do not fit within the context, are not part of a word in the language of the collection, or are otherwise inconsistent with the collection. The flow 500 continues with modifying the pulling to avoid the extraneous characters 530. The algorithm for scraping may be modified to avoid specific characters, avoid locations on a page, or otherwise avoid certain arrangements. Numerous other types of scraping improvements are possible. In some embodiments, a scraping improvement may include context sensitive modifications. When a certain institutional library service is being scraped, a location change may be identified for a certain field. For example, an author listing may be in a certain web page location and further scraping of that or similar locations will be performed for author names. Likewise, a keyword may be identified as being associated with publication dates. Further scraping may be modified to look for that keyword in order to improve the scraping. Many other improvements are similarly possible. Various steps in the flow 500 may be changed in order, repeated, omitted, or the like without departing from the disclosed inventive concepts.

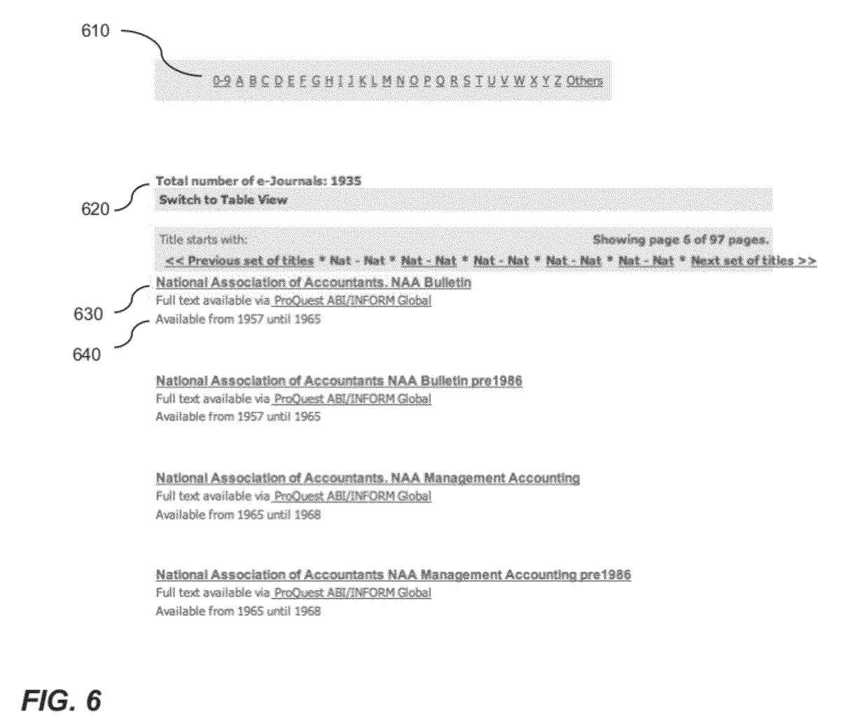

FIG. 6 is an example web page for scraping. An “A to Z” page is shown. The alphanumeric sequence 610 with “A to Z” letters as well as numbers are shown with links to other web pages for these letters and numbers. Each of these further web pages may be stepped through and scraped for further collection information. A total number of electronic journals 620 is shown. A first entry 630 is displayed along with the date range of availability 640. In some embodiments, each of the “A to Z” entries 610 will be associated with further web pages. The first entry 630 on the web page shown in FIG. 6 may be scraped for collection information as may each subsequent entry on the web page.

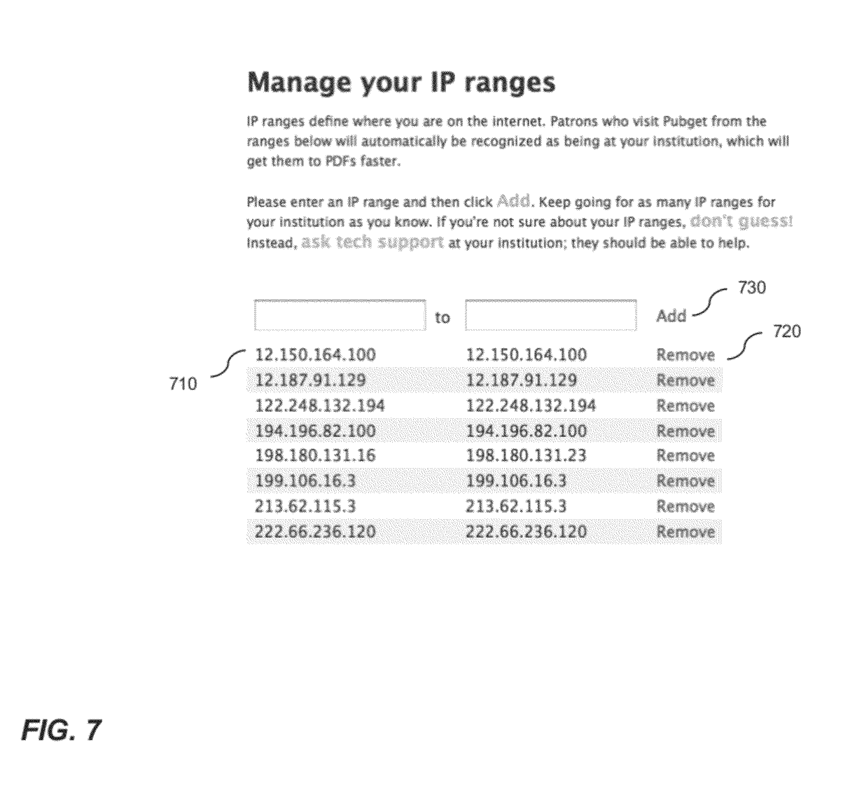

FIG. 7 is an example web page showing IP address ranges. IP address ranges are useful in accessing publishing platforms or institutional library services. Access to one of these platforms or services may be restricted to a specific IP range. A first IP range 710 is shown. A new IP range may be included by selecting the Add button 730. An existing IP range may be deleted by selecting the Remove button 720. In some embodiments, these IP ranges may be reported via a software tool to a librarian or other user. The librarian may review the IP ranges for correctness to ensure access to the proper materials from a publisher. When an incorrect IP range is found, access to the correct IP range may be requested and granted.

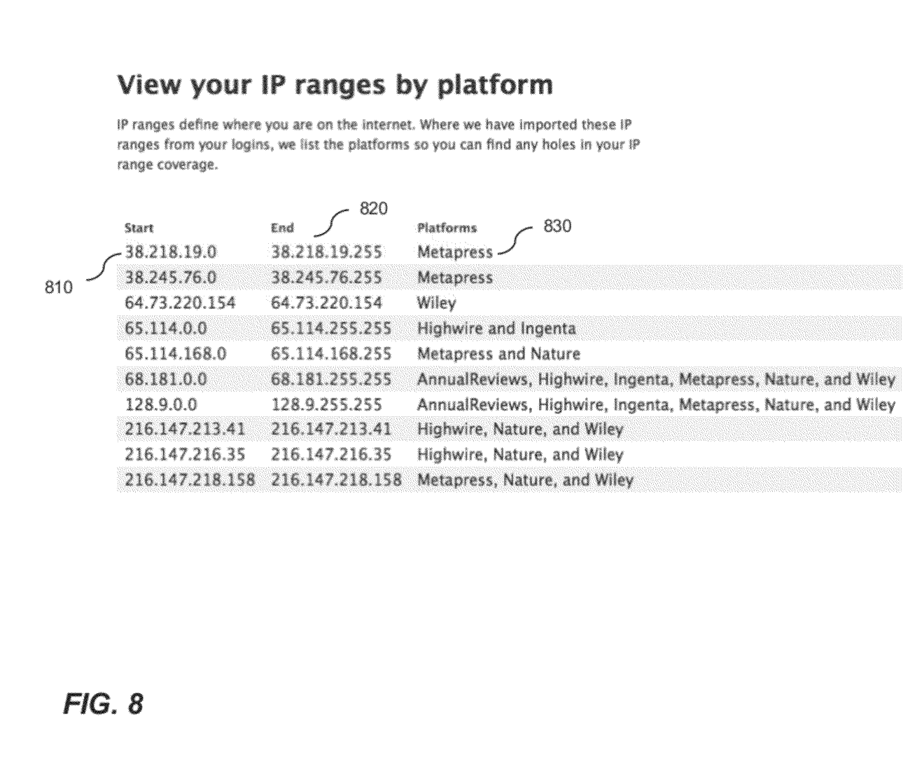

FIG. 8 is an example web page showing IP ranges by platform. A starting IP address 810 and an ending IP address 820 are shown for a specific platform 830. The IP ranges can be managed on a platform by platform basis. By reviewing such a display, deficiencies can be identified in the IP ranges covered.

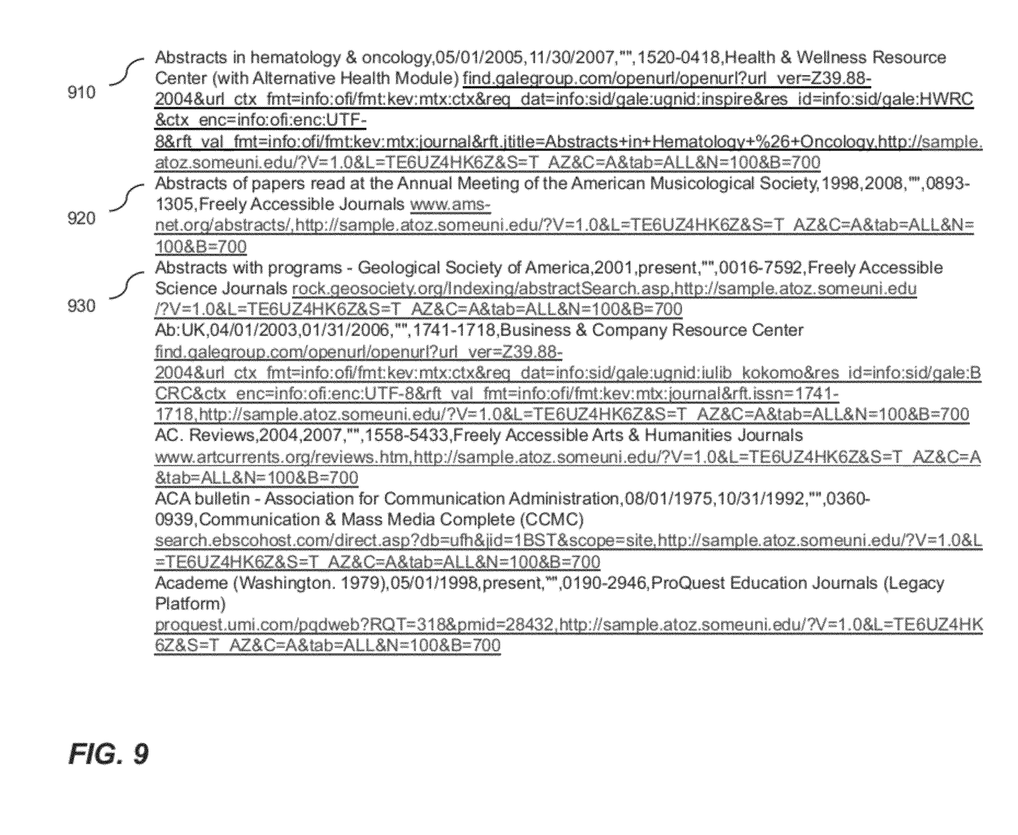

FIG. 9 includes example spreadsheet information on collections. A first entry 910, a second entry 920, a third entry 930, and so on are displayed. For each entry, the collection title, start date for the collection, end date for the collection, any embargo dates, an ISSN number, the source of the collection, and the holding URL is displayed. Each of the fields is separated by a comma. In other embodiments, various other information may be displayed. The fields may be separated by tabs or other delimiters. The collection information may be gathered by importing or scraping according to the methods described earlier.

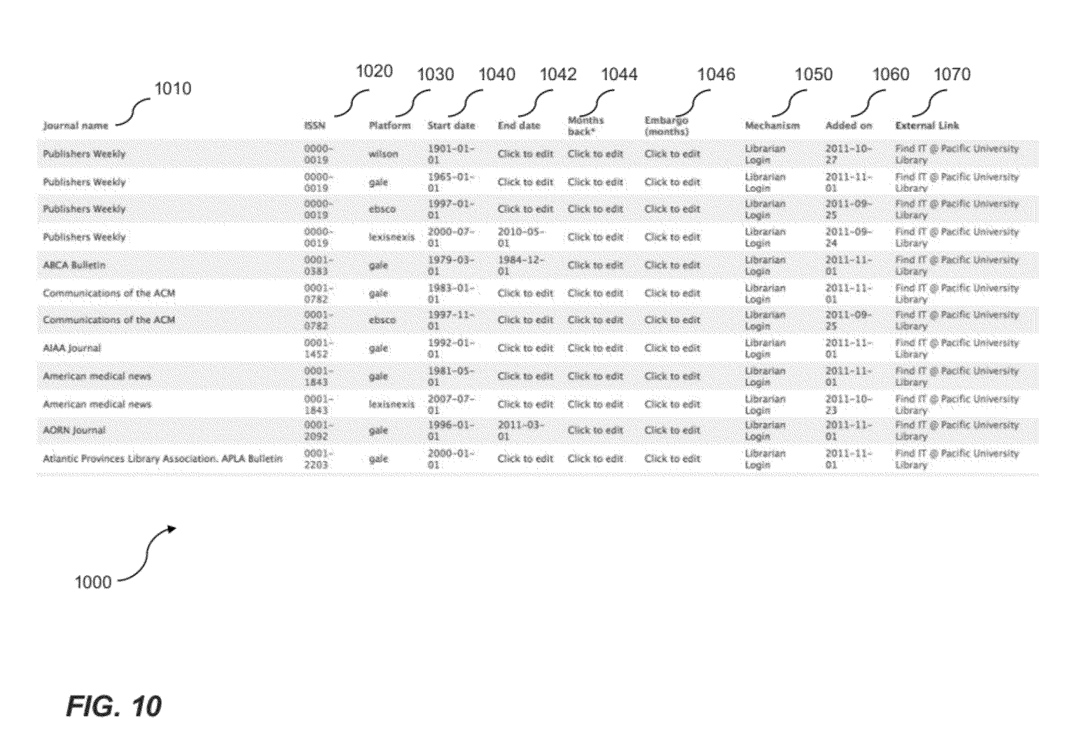

FIG. 10 includes an example view of holdings. A web page 1000 is shown which includes information gathered on a collection. A journal name 1010 is shown along with its ISSN number 1020. The platform 1030 on which the journal resides is provided. Start dates 1040 and end dates 1042 for the collection is provided along with any back months 1044 or embargo (missing) months 1046. The mechanism 1050 by which the collection information was obtained is listed as well as the date on which the information was added 1060. An external link 1070 for the collection is given. Other information may be collected. The collection information may be stored, emailed, hard copy mailed, printed, and so on.

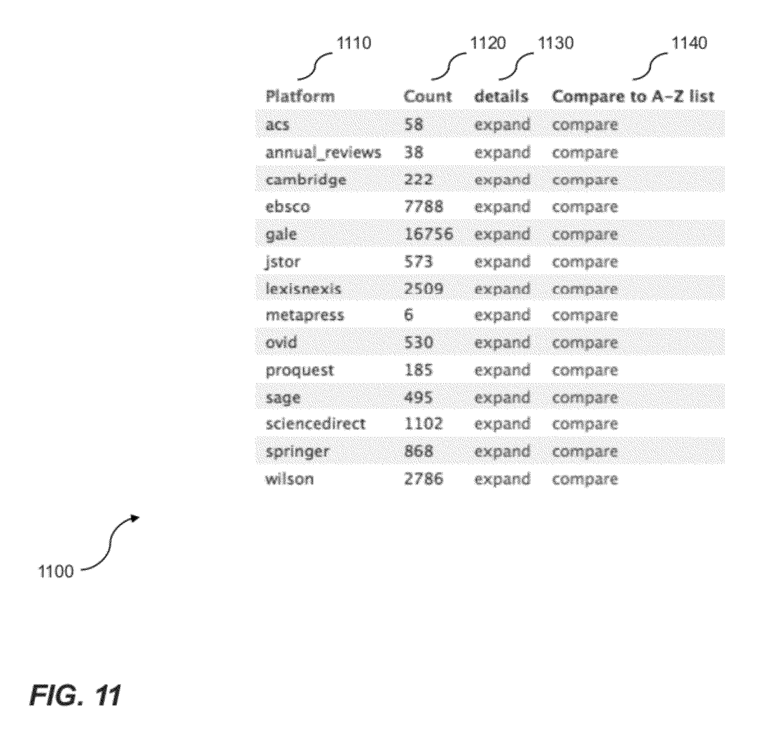

FIG. 11 includes an example overview of holdings. A web page 1100 is shown which includes collections information. The platform 1110 on which a journal or other material may be obtained is provided. The count 1120 for the number of journals on the platform 1110 is provided. Further details 1130 may be provided on the platform 1110 by clicking on the corresponding “expand” link. A Compare to A-Z list 1140 entry is provided in order to compare information on the collection with that information which is contained on the platform's A-Z page. Other information may be collected. The collection information may be stored, emailed, hard copy mailed, printed, and so on.

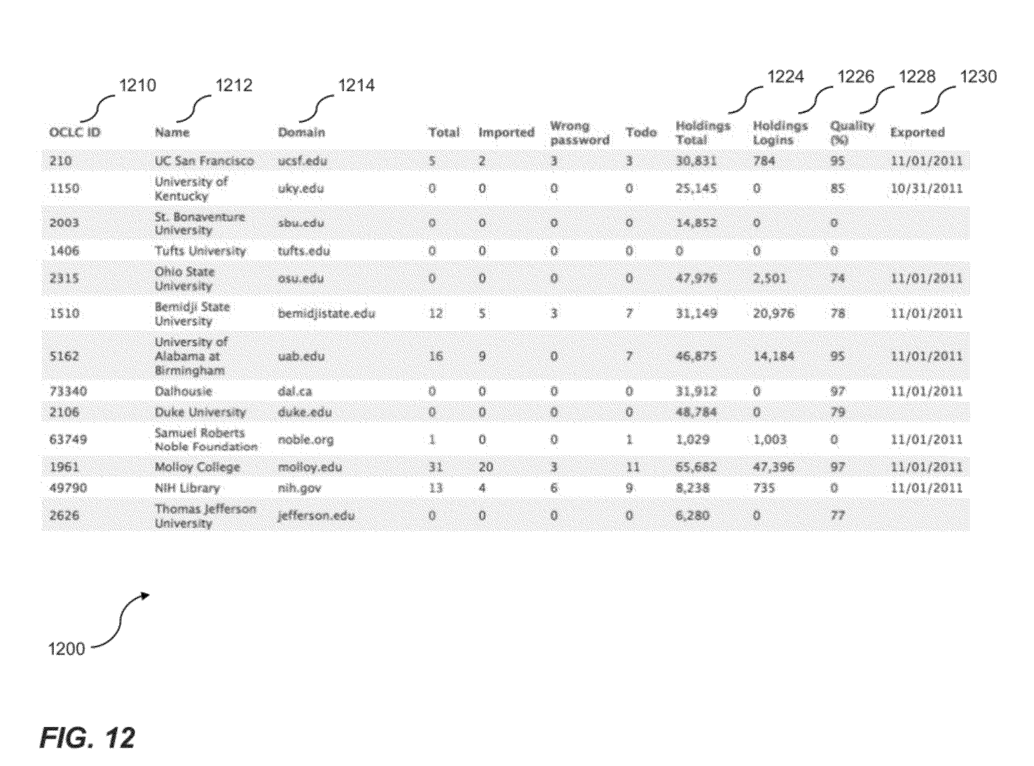

FIG. 12 includes an example library report. A web page 1200 is shown which includes collections information provided to a library or similar institution. The online computer library center (OCLC) identity 1210 for libraries is provided. The name 1212 for the corresponding libraries is provided. The web domain name 1214 for the library is shown along with various other information. Included is the holdings total 1224, describing the number of serials or other contents for the library. The number of logins 1226 performed to obtain information on collections is listed. A quality metric 1228 is provided based on analysis of data related to the collections for the library as well as the date on which the information was exported 1230.

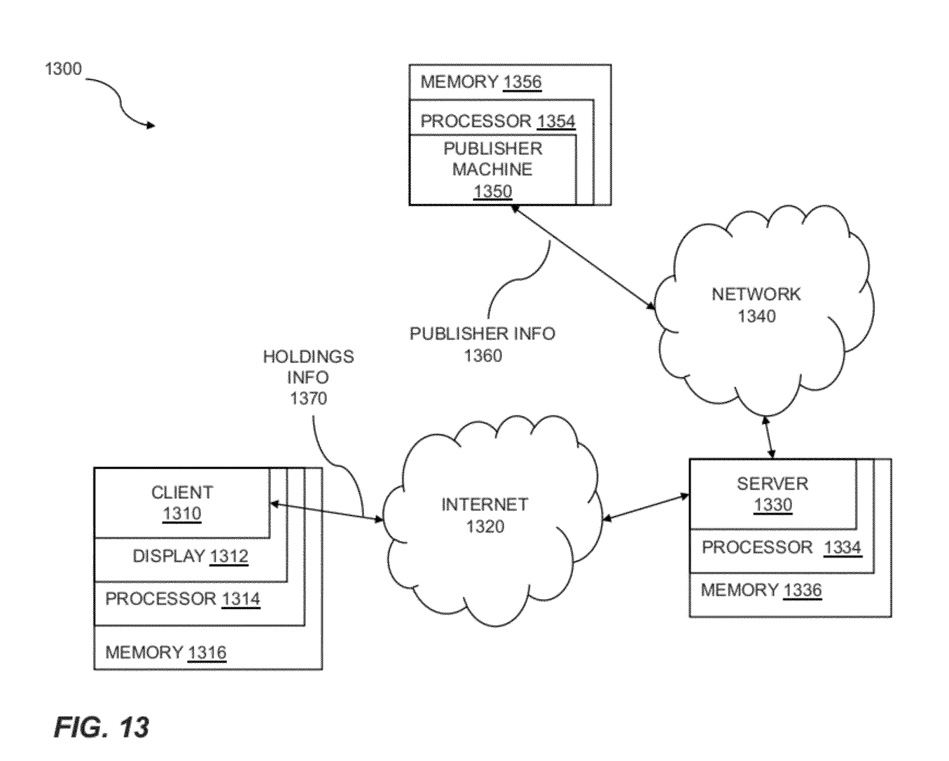

FIG. 13 is a system diagram showing client server interaction. A client 1310 is shown receiving holdings information 1370 across the Internet 1320 from a server 1330. The server 1330 receives publisher information 1360 from a publisher machine 1350 across a network 1340. The Internet 1320, intranet, or other computer network may be used for communication between or among various computers including the client 1310 and the server 1330. Communication between the server 1330 and the publisher machine 1350 may be across the Internet, intranet, or other computer network. In some embodiments, the network between the client 1310 and the server 1330 is the same network as that used between the server 1330 and the publisher machine 1350.

The client computer 1310 may comprise a display 1312, a processor 1314, and a memory 1316. The memory 1316 may be used for storing instructions, for storing collections data, for system support, and the like. The memory 1316 may comprise one or more memories. The memory 1316 may be connected to one or more processors 1314 wherein the one or more processors 1314 can execute instructions stored in the memory 1316. The client computer 1310 also may have an Internet connection to carry collections or holdings information 1370. The display 1312 may present various information on collections to one or more viewers. The display may be any electronic display, including but not limited to, a computer display, a laptop screen, a net-book screen, a tablet computer screen, a cell phone display, a mobile device display, a remote with a display, a television, a projector, or the like. In some embodiments there are multiple client computers 1310.

The holdings information 1370 may be obtained from the server 1330. The client computer 1310 may communicate with the server 1330 over the Internet 1320, intranet, some other computer network, or by any other method suitable for communication between two computers using wired, wireless, and other communications technologies. In some embodiments, the functions of the client 1310 and the server 1330 are performed in the same machine.

The server computer 1330 may comprise a processor 1334, and a memory 1336. The memory 1336 may be used for storing instructions, for storing collections data, for system support, and the like. The memory 1336 may comprise one or more memories. The memory 1336 may be connected to one or more processors 1334 wherein the one or more processors 1334 can execute instructions stored in the memory 1336. The server 1330 also may have an Internet connection to carry collections or holdings information 1370. The server 1330 also may have a network connection to carry publisher information 1360.

The publisher information 1360 may be obtained from the publisher machine 1350. The server 1330 may communicate with the publisher machine 1350 over the Internet, intranet, some other computer network, or by any other method suitable for communication between two computers using wired, wireless, and other communications technologies. In some embodiments, publisher machine 1350 is a third party machine.

The publisher machine 1350 may comprise a processor 1354, and a memory 1356. The memory 1356 may be used for storing instructions, for storing collections data, for system support, and the like. The memory 1356 may comprise one or more memories. The memory 1356 may be connected to one or more processors 1354 wherein the one or more processors 1354 can execute instructions stored in the memory 1356. The publisher machine 1350 also may have an Internet or network connection to carry publisher information 1360.

In embodiments, the system 1300 includes computer program product embodied in a non-transitory computer readable medium for obtaining information with code for executing various steps for handling collections information. In embodiments, the system 1300 includes a memory for storing instructions and one or more processors attached to the memory wherein the one or more processors are configured to handle collections information.

Each of the above methods may be executed on one or more processors on one or more computer systems. Embodiments may include various forms of distributed computing, client/server computing, and cloud based computing. Further, it will be understood that for each flowchart in this disclosure, the depicted steps or boxes are provided for purposes of illustration and explanation only. The steps may be modified, omitted, or re-ordered and other steps may be added without departing from the scope of this disclosure. Further, each step may contain one or more sub-steps. While the foregoing drawings and description set forth functional aspects of the disclosed systems, no particular arrangement of software and/or hardware for implementing these functional aspects should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. Each element of the block diagrams and flowchart illustrations, as well as each respective combination of elements in the block diagrams and flowchart illustrations, illustrates a function, step or group of steps of the methods, apparatus, systems, computer program products and/or computer-implemented methods. Any and all such functions may be implemented by computer program instructions, by special-purpose hardware-based computer systems, by combinations of special purpose hardware and computer instructions, by combinations of general purpose hardware and computer instructions, by a computer system, and so on. Any and all of which implementations may be generally referred to herein as a “circuit,” “module,” or “system.”

A programmable apparatus that executes any of the above mentioned computer program products or computer implemented methods may include one or more processors, microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are not limited to applications involving conventional computer programs or programmable apparatus that run them. It is contemplated, for example, that embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized. The computer readable medium may be a non-transitory computer readable medium for storage. A computer readable storage medium may be electronic, magnetic, optical, electromagnetic, infrared, semiconductor, or any suitable combination of the foregoing. Further computer readable storage medium examples may include an electrical connection having one or more wires, a portable computer diskette, a hard disk, a random access memory (RAM), a read-only memory (ROM), an erasable programmable read-only memory (EPROM), Flash, MRAM, FeRAM, phase change memory, an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. Each thread may spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the entity causing the step to be performed.

While the invention has been disclosed in connection with preferred embodiments shown and described in detail, various modifications and improvements thereon will become apparent to those skilled in the art. Accordingly, the spirit and scope of the present invention is not to be limited by the foregoing examples, but is to be understood in the broadest sense allowable by law.

1. A computer implemented method for obtaining information comprising:
accessing a publishing platform;
importing data related to a collection from the publishing platform;
analyzing the data related to the collection which was imported, resulting in an analysis; and
storing the analysis in a computer system.

2. The method of claim 1 wherein the collection includes one or more of electronic books, electronic journals, and papers.

3. The method according to claim 1 wherein the accessing is accomplished by navigating to a publicly available page.

4. The method according to claim 1 wherein the accessing is accomplished by logging into the publishing platform using one of a group including a known login, a proxy login, and a VPN.

5. The method of claim 1 wherein the importing includes downloading one or more files containing the data related to the collection.

6. The method according to claim 1 wherein the importing further comprises:
navigating to a page containing the data related to the collection; and
grabbing subscription information on the collection.

7. The method according to claim 6 further comprising scraping the page, which was navigated to, for additional information beyond that which was grabbed.

8. The method according to claim 1 further comprising improving the importing by:
identifying an alias for a title of the collection from the publishing platform; and
analyzing the data related to the collection using the alias for the title.

9. The method according to claim 1 further comprising storing the data related to the collection for future usage.

10. The method according to claim 1 wherein the data related to collections includes one or more from a group consisting of an electronic journal URL, database information, an ISSN number, an ISBN number, dates for the collection, a source for the collection, and availability of the collection.

11. The method according to claim 1 further comprising determining whether a quality criterion is met by the data related to the collection.

12. The method according to claim 1 further comprising identifying an error in the data related to the collection.

13. (canceled)

14. The method according to claim 12 further comprising notifying the publishing platform of the error which was identified.

15. The method of claim 1 further comprising monitoring the collection from the publishing platform to identify changes in the collection.

16. A computer implemented method for obtaining information comprising:
accessing an institutional library service;
scraping the institutional library service for data related to a collection;
analyzing the data related to the collection which was scraped, resulting in an analysis; and
storing the analysis in a computer system.

17. The method according to claim 16 wherein the scraping further comprises:
identifying a location of a starting page for the institutional library service;
plugging in an arrangement for the data related to the collection on the starting page;
pulling the data related to the collection from the arrangement; and
exporting the data related to the collection into a database.

18. The method according to claim 17 further comprising formatting the data related to the collection into a spreadsheet.

19. The method according to claim 17 further comprising improving the scraping by:
marking a row within the database for analysis;
identifying extraneous characters in the data related to the collection within the row; and
modifying the pulling to avoid the extraneous characters.

20. A computer program product embodied in a non-transitory computer readable medium for obtaining information, the computer program product comprising:
code for accessing a publishing platform;
code for importing data related to a collection from the publishing platform;
code for analyzing the data related to the collection which was imported, resulting in an analysis; and
code for storing the analysis in a computer system.

21. A computer system for obtaining information comprising:
a memory for storing instructions;
one or more processors attached to the memory wherein the one or more processors are configured to:
access a publishing platform;
import data related to a collection from the publishing platform;
analyze the data related to the collection which was imported, resulting in an analysis; and
store the analysis in a computer system.

22-23. (canceled)
